(19) United States
(12) Patent Application Publication
(10) Pub. No.: US 2017/0012508 A1
(43) Pub. Date: Jan. 12, 2017

(54) LAMINATION STACKS FOR ELECTRIC MOTORS/GENERATORS

(71) Applicant: SWD AG, Densbueren (CH)

(72) Inventor: Georg SENN, Densbueren (CH)

(73) Assignee: SWD AG, Densbueren (CH)

(21) Appl. No.: 15/270,505

(22) Filed: Sep. 20, 2016

(51) Int. Cl. H02K 15/02; H02K 15/12

(52) U.S. Cl. CPC H02K 15/02; H02K 15/12

(57) ABSTRACT

A process for producing metal bodies, in particular for the production of stators for use in electric motors, has a plurality of steps. Firstly, a stack of a plurality of sheet metal parts is introduced into a cavity of a tool, with thermally curing adhesive layers being provided between the sheet metal parts. The stack is then heated to effect curing of the adhesive layers, forming the metal body. During heating, a pressure is applied to the stack. At least one of the following parameters is measured during the process: applied pressure, temperature of the stack, height of the stack. A prescribed height of the stack is set by use of a temperature-pressure control. The BPS™, BPS-Backpaketiersystem™ or Backpaketiersystem™ according to the invention makes efficient and precise production of stators possible, is self-learning and allows measurement, regulation and recording of all production parameters during production of each single stator. In particular, all production parameters can be afterwards assigned to an individual stator.

### TECHNICAL FIELD

The invention relates to a process for producing metal bodies for the production of primarily segmented stator lamination packets for use in electric motors, having the steps of stamping and formation of a stack of laminations in a cavity of a tool, with thermally curing adhesive layers being provided between the sheet metal parts, and heating of the stack to cure the adhesive layers and to form the metal body, with a pressure being applied to the stack during heating.

### PRIOR ART

The demand for electric motors, generators and electric machines in general is increasing continually because of, inter alia, the increasing numbers of electric vehicles and hybrid cars. For this reason, stators and rotors have to be produced in an increased number and with high accuracy, with the production costs at the same time being very low and the production process saving as much material as possible. One technology employed here is the production of lamination packets from magnetic single lamellae.

DE 38 29 068 C1 (Mannesmann) describes a process for adhesively bonding (baking together) laminations which have been stamped in an automatic machine and have been provided with an adhesive insulating layer. For this purpose, the individual stamped parts are placed on top of one another and adhesively bonded (baked together) under the action of heat and axial pressure. To decrease the time and energy requirement significantly, each individual stamped part is heated to the reaction temperature of the baked varnish while being placed in position and then immediately pressed onto the previously positioned stamped part. Heatable contact plates are provided both on the pressing punch and in the die, so that the stack can be heated from below and above (i.e. from its ends). The stack having the desired height is then cooled. In this way, heating/baking of the individual stamped parts is carried out instead of baking of the entire stack after the finished height has been reached. The difference from the process presented here is that the same baking-together pressure is again applied temporarily to the previously baked stamp parts with each further baked-on stamped part and the height of the stack can be controlled only to within the thickness of a stamped part.

DE 31 10 339 A1 describes a process for producing lamination packets. Here, lamellae are stamped by means of a punch from a lamination strip coated on both sides with precured thermoset adhesive and these then fall into a magazine arranged underneath the cutting plane. In the magazine, the lamellae are either counted or weighed and stacked in an aligned manner to form a packet. The packet is transported in the magazine by means of a conveyor firstly through a curing zone in which adhesive bonding is effected by heating to about 230 degrees Celsius under pressure. The packet is then transported into a cooling zone, taken from the magazine and coated with corrosion protection in an apparatus. The difference from the process presented here is the transfer of the stack of lamellae into various work stations.

JP 2007/059819 A (Kuroda Precision IND LTD) relates to production of an iron core for an electric machine. A band of magnetic steel is rolled off and fed to the press, with finished iron cores being transported away by a transport device. Heating and cooling facilities for a stamping apparatus and a layer bonding apparatus are provided. The layer bonding apparatus has a compressible ring which is in contact with a piece of the layer material. A plurality of hot air inlets have been drilled in and a thermal insulation ring is provided. The layer material is heated both from the inside and from the outside in order to cure the adhesive between the layers promptly and achieve an increase in productivity.

JP 2009/297758 A (Kuroda Precision IND LTD) relates to the production of coated iron cores, in which two or more layers are adhesively bonded by means of a thermal adhesive. The apparatus comprises stamping tools, platelet punches and an adhesive applicator. A pressing sheath accommodates the sheet metal parts and has the same internal diameter as the stamping die. A heating device in the form of a heating coil is accommodated in the pressing sheath. In order for the heating energy to flow away to the outside as little as possible, a cylindrical vacuum insulator and two disc-shaped insulation bodies are provided. A punch holds the coated iron core in position in the axial direction. There is therefore contact between the materials of the sheet metal parts and pressing sheath and the heating energy is transmitted via this contact from the tool to the sheet metal parts in order to cure the adhesive.

JP 56 091656 A (Matsushita Electric IND CO LTD) relates to monitoring of the thickness of a coated iron core. A plate is stamped out and the thickness of the plate is measured by means of a contacting thickness sensor. Here, an error due to wear of the sensor and to temperature changes is determined and corrected according to a formula when a proximity detector detects the lower section.

The present processes for forming packets of welded and baked/adhesively bonded packets need to be optimized and improved in terms of economics.

### PRESENTATION OF THE INVENTION

It is an object of the invention to provide a process which belongs to the technical field mentioned at the outset and by means of which metal bodies, in particular a stack of lamellae, for use in electric motors can be produced particularly inexpensively, process stable and efficiently.

The object is achieved by the features of claim 1. According to the invention, at least one of the following parameters is measured during the process:
applied pressure,
temperature of the stack,
height of the stack (length).

Furthermore, according to the invention, a prescribed height of the stack is set by use of a temperature-pressure control. This means that the temperature and the pressure can be controlled in such a way that the stack precisely reaches a predetermined height (this is not absolutely necessary). This can be achieved by varying only the pressure, varying only the temperature, varying only the time or, particularly preferably, varying the temperature, the time and the pressure. As a result, the parameters can be adapted during heating in so far as the stack height changes. The inventive BPS-Backpaketier-System™, or the Backpaketiersystem™ enables fluctuations in the materials properties to be accommodated by altering the parameters during the process.

In the production process, a stack is firstly formed from a plurality of sheet metal parts in a cavity of the tool. Thermally curing adhesive layers are provided between the sheet metal parts. These adhesive layers cover a substantial part of the surface of the sheet metal piece in such a way that a firm, areal bond between the two surfaces of the superposed sheet metal parts can be formed. However, it is not absolutely necessary for the adhesive layers to extend over the entire surface of the sheet metal parts. To cure these adhesive layers and thus to form the sheet metal stack body, the sheet metal parts are heated.

The process of the invention can be implemented by means of an apparatus having a compact construction. Working steps can be integrated in a single apparatus, with two working steps being able to proceed at least partly simultaneously. Furthermore, the apparatus can be easily constructed in a modular fashion, with different number-of-parts performances being able to be provided. In this way, the apparatuses can be adapted in a simple and efficient way and specifically for the customer and also be supplied quickly in the desired configuration or be adapted on site.

In this way, complicated production lines are reduced to a single machine, which saves money, simplifies maintenance and minimizes the space requirement. In addition, production is accelerated.

The preferred field of application of the process of the invention is the production of segmented stators for electric motors, but can also be employed for other forms of lamination stacks.

Stators are, depending on the design, the stationary parts in an electric motor, while the rotor is configured so as to be rotatable relative to the stator. But it can also be the opposite way.

The invention can, however, also be used for the production of components of further dynamoelectric machines, in particular magnetic cores made up of metal sheets for transformers, but also for the production of sensors, actuators, etc.

The tool is preferably configured as a cavity, with the stack being formed within the cavity by a stamping process and, in particular, the cavity partly or completely enclosing the stack. The sheet metal parts are stamped or cut under the action of pressure by means of a stamping punch or a die of the stamping unit. The process is also known as stamping. The sheet metal parts are thus typically introduced into the cavity.

Stamping is a particularly efficient and precise method of producing many sheet metal parts on site. The sheet metal parts can be introduced or pressed into the cavity in various ways, for example individually by means of a stamping punch, a ram or by means of an air pressure pulse or else by successive stacking and blockwise pressing-in of the sheet metal parts.

Arranging the cavity in the direct vicinity underneath the stamping plane of a stamping machine so that the freshly stamped sheet metal part can be introduced or pushed directly into the cavity and transport processes and manipulations of the sheet metal part, e.g. alignment thereof, can be saved is particularly advantageous. The lamellae are optionally accompanied by an apparatus configured as a pressure pad. The entrance of the cavity is in this case formed by the stamping die and the cavity represents in its totality an extension of the stamping die in the stamping direction. The stamping punch can introduce the sheet metal parts simultaneously into the cavity.

As an alternative, the sheet metal parts can also be shaped in a manner other than by stamping, for example by laser cutting or parting from larger sheet metal parts. Furthermore, the cavity does not necessarily have to completely enclose the stack; it can be sufficient, for example, for the cavity to be of such a nature that the stack can be held sufficiently precisely in position.

The stack height is preferably measured by means of a punch in the cavity. The punch serves firstly to hold the sheet metal parts in position during the heating phase, i.e. to apply the pressure, and secondly to measure and regulate the stack height. The stack height can be measured firstly by means of a distance of travel of the punch or else via the pressure of the punch, via conductivity between punch and cavity, via an elasticity of the stack, etc. Thus, for example, the pressure can be increased by means of the punch during heating in order to compensate for expansion of the stack. The pressure can, however, also be varied during the heating phase in such a way that the properties of the adhesive layer are optimally taken into account in order to achieve efficient and precise curing.

As an alternative, the stack height can also be measured by other means, for example via a band thickness measurement.

The stack is preferably transferred fully automatically to a joining station. The initially still loose sheet metal parts located above one another are there joined to one another by means of the adhesive layer. The transfer is preferably effected by means of a robot or a similar device. The stack can in this way be positioned particularly efficiently and precisely in the joining station.

The joining station or the further processing can also be implemented directly under the die by means of a rotating station, a revolving magazine or a carrousel.

The stack is preferably heated in the joining station to form the stack of lamellae, in particular baked together. The adhesive is in this way activated so that the individual sheet metal parts are held together.

As an alternative, the heating operation can be omitted, especially when the adhesive does not have to be cured under the action of heat or when joining is effected by welding.

The stack is preferably subjected to a baking process in the joining station, with the stack being heated by a fluid or direct or indirect magnetical and subsequently cooled, in particular actively, so as to give a metal body. For this purpose, the apparatus preferably comprises a heating facility, in particular with a fluid or a direct or indirect electromagnetic heating facility, and a cooling facility.

The direct heating of the stack has the advantage that the process can be carried out very precisely. Furthermore, this allows intervention into the heating-up process with little time delay, especially since heating with fluids or direct or indirect erlectromagnetic acts directly and typically has a short reaction time. Furthermore, particularly uniform heating of the individual sheet metal parts of the stack can be achieved in this way.

The use of active cooling enables the production process to be configured particularly efficiently or a cycle time to be kept short, especially when the metal body cannot or is not to be taken from the cavity at elevated temperature. This can be the case when the adhesive bond in the hot metal body is not strong enough or when the metal body can be taken from the cavity more easily after it has been cooled. The cooling process is preferably effected by introduction of a cooling fluid such as cooling air or water.

In variants, the stack can also be heated in another way, for example by heating cartridges. The cooling process can also be carried out in another way or cooling of the stack can also be dispensed with.

The stack height is preferably measured by means of a punch in the cavity. The punch serves firstly to hold the sheet metal parts in position before, during and after (for example in the case of a cooling process) the heating phase, i.e. to apply the pressure, and secondly to measure and regulate the stack height. The stack height can firstly be measured via a distance of travel of the punch or else via the pressure of the punch, via a conductivity between punch and cavity, via an elasticity of the stack, etc. Thus, the pressure can be increased by means of the punch, for example during heating, in order to compensate for expansion of the stack. However, the pressure can also be varied during the heating phase in such a way that the properties of the adhesive layer are optimally taken into account in order to achieve efficient and precise curing.

In variants, the stack height can also be measured by other means. As an alternative, measurement of the stack height can also be dispensed with.

Individual process parameters, in particular a process parameter selected from among:
a) a power for heating the stack,
b) a hold time of a temperature after heating of the stack,
c) a pressure by means of which a stack is held during heating,
during the baking process are preferably adapted individually for each stack.

Adaptation of the process parameters serves, in particular, to reduce a production time for a metal body and can be effected dynamically during heating/cooling and is not restricted to the abovementioned process parameters.

In contrast to known processes, the height is thus not only measured but also regulated actively on the basis of the current measured values. In this way, the parameters can be optimized during the process. In particular, the pressure applied to the stack can be increased. The temperatures can also follow any curve and the times can be varied. In a further advantageous embodiment of the process, the measured data in respect of the stack height and also the temperatures are stored in order to firstly document the production process and secondly be able to optimize the process further. Likewise, quality features can be determined, stored and evaluated.

In variants, adaptation of process parameters during the process can also be omitted.

After cooling of the metal bodies, the metal bodies are preferably taken from the cavity, preferably fully automatically, in particular in an ejection station. For this purpose, the cavity is firstly transferred into an ejection station. The finished metal body is subsequently ejected from the cavity, for example by means of a punch.

In variants, the metal body can also be taken from the cavity before cooling.

The process is preferably carried out fully automatically and continuously. Thus, stamping of the metal sheets and thus stacking of the metal sheets, and also the heating and cooling of the stack and finally the taking of the metal body from the cavity, are preferably carried out in a continuous process. In brief, the production line from unstamped metal sheet, which is, for example, supplied in rolls, through to the finished metal body is carried out in a continuous process.

In variants, it is possible, for example, for the stack of metal sheets or other intermediates to be produced in a first step and the finished metal sheet body to be made in a further, separate step. Individual working steps can thus also be carried out locally separately. It would also be conceivable to produce the individual metal sheets beforehand and supply them to the system separately. In particular, complex sequences of lamellae could be joined to form a stack in this way.

The individual process parameters are preferably stored for each metal body produced. In combination with a serial number apllied on the stack, it is in this way possible to rediscover later how a particular metal body was produced. Subsequent tests on the metal bodies can in this way be reduced or entirely avoided, as a result of which the overall process can be made more efficient. The measured process parameters can be compared automatically with a respective intended range, so that reject goods can be recognized efficiently and sorted out. In addition, the process parameters can be optimized particularly efficiently with the aid of the stored values and on the basis of random samples. Furthermore, the process parameters can be adapted automatically and dynamically on the basis of the stored values of the immediately preceding production of one or more metal bodies.

In variants, individual measurement of the process parameters can also be dispensed with. It can, for example, also be sufficient to store a moving average of the process parameters over a plurality of metal bodies.

The stamping unit, the joining station and the ejection unit are preferably coordinated by means of a computer unit. In this way, the throughput of the stamping unit, for example, can be matched to the throughput of the joining station in order to avoid a “traffic jam” before the joining station. The coordination can, furthermore, be of such a nature that a plurality of units are in each case controlled in such a way as to maintain an optimal throughput. Furthermore, for example, a plurality of joining stations can in the case of overcapacity be controlled in such a way that a cooling process occurs passively in order to save energy. A person skilled in the art will also know of further optimization opportunities.

In variants, the stamping unit, the joining station and the ejection unit do not necessarily have to be coordinated via a computer. It can be sufficient to match the throughput of each station/unit to the smallest capacity.

An apparatus for carrying out the process comprises a stamping unit, a joining station and an ejection unit, with the joining station comprising a plurality of preferably identical packeting modules which can be supplied by the stamping unit. This configuration is particularly advantageous since the stamping apparatus typically has a high capacity compared to a joining station, i.e. more stacks can be produced per unit time by a stamping apparatus than can be packeted by a joining station. The ejection unit likewise has a higher capacity than the joining station. The joining station is thus the rate-determining step in the process, while the stamping apparatus having a single stamping module is not being operated at full load. The joining unit having a plurality of modules enables the capacity of the stamping unit to be exploited and the process thus to be optimized.

As an alternative, the joining station can be configured in such a way that a plurality of cavities with the stacks can be processed simultaneously, in the same module. Furthermore, it is also possible for a plurality of stacks to be processed simultaneously in a cavity.

The apparatus for supplying the joining station and for the transfer preferably comprises an automatic device.

In principle, individual or a number of processing stations can be encompassed. The supply and the transfer can, as an alternative, also be carried out manually.

The process allows fully automated production and thus highly rational, process-capable and reproducible manufacture. The production plant displays high modularity, flexibility, self-monitoring and self-optimization and also ability of the production process to be documented. The apparatus can therefore produce completely autonomously and does not require any specific know-how of the user. The stamping tool is preferably likewise easy to change for maintenance work such as after-grinding, etc. Due to the high degree of automation, the place in which the production plant is to be erected can be chosen flexibly. In particular, decentralized monitoring of the function of the production plant is possible.

Depending on the production volume required, the speed of punching can be varied or the number of joining stations can be increased. Thus, even small production runs or run start-ups can be carried out rationally and the production volume can be increased virtually steplessly. Very high cycles time can be achieved.

Likewise, individual part monitoring is made possible by control of the parameters in the stamping unit and in the joining stations and production parameters can be determined and stored for each part. One hundred percent traceability can therefore be achieved.

Further advantageous embodiments and combinations of features of the invention can be derived from the detailed description below and the totality of the claims.

### BRIEF DESCRIPTION OF THE DRAWINGS

The drawings used to illustrate the working example show:

FIG. 1a a schematic depiction of a stamping unit;

FIG. 1b a schematic depiction of a joining station;

FIG. 1c a schematic depiction of an ejection unit;

FIG. 2 a schematic depiction of a joining station configured as welding station/baking station, and

FIG. 3 a schematic depiction of a joining station configured as heating station.

The same parts are basically denoted by the same reference numerals in the figures.

### WAYS OF CARRYING OUT THE INVENTION

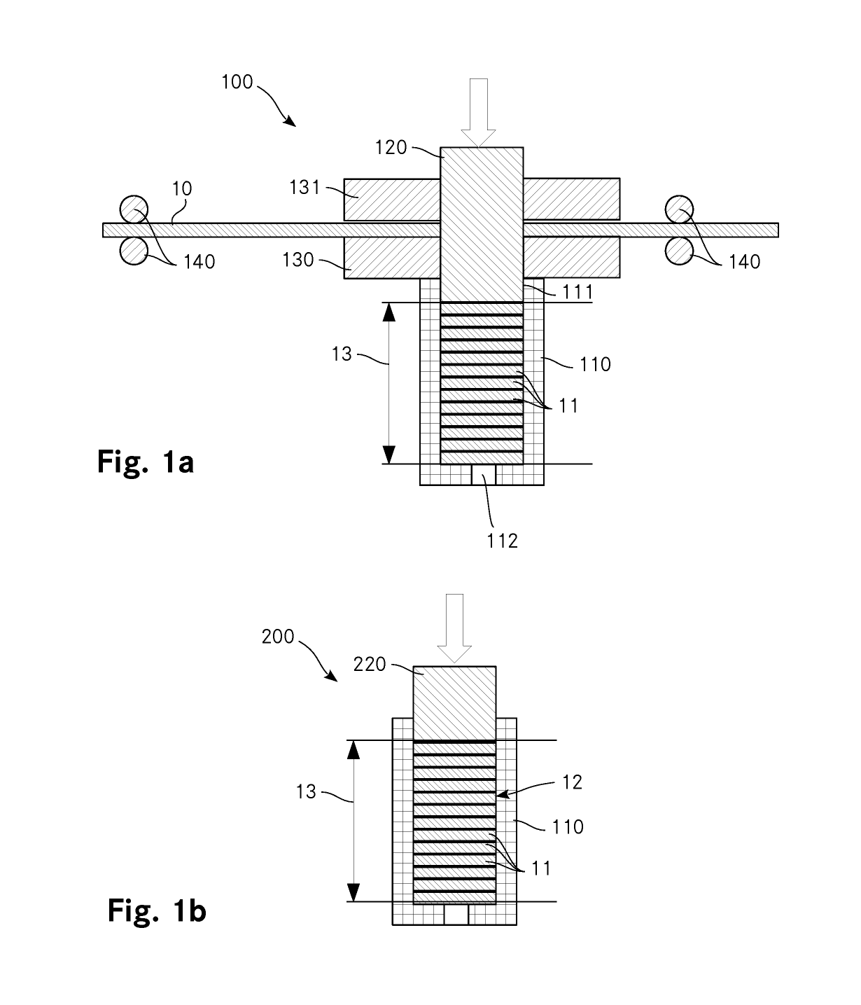

FIG. 1a shows a schematic depiction of a stamping unit 100. This comprises a cavity 110, a punch 120, a die 130 with punch guide 131 and also one or two band controls 140 for guiding the coated metal sheet 10.

The stamping unit 100 comprises a die 130 having a punch guide 131, which are spaced relative to one another so that a metal sheet 10 can be passed between the stamping die 130 and the punch guide 131. The die 130 and the punch guide 131 comprise an opening for passage of the stamping punch 120. A cavity 110 for accommodating the stamped sheet metal parts 11 is arranged in line with the opening of the die 130.

The cavity 110 is essentially configured as a cylindrical cavity in which the sheet metal parts 11 are stacked to form a stack 12. For this purpose, the cavity 110 has an inlet opening 111 through which the sheet metal parts 11 are introduced into the cavity by the stamping process itself. Opposite the inlet opening 111, there is an ejection opening 112 through which the finished metal body 13 can be ejected (see FIG. 1c). The cavity 110 is configured so that it holds the sheet metal parts 11 securely in position during production of the metal body—for this purpose, the cavity 110 can completely or partly enclose the sheet metal parts 11. The interior of the cavity 110 and the inlet opening have a shape corresponding to the sheet metal parts 11.

In the process, the metal sheet 10, which can, in particular, be present as rolled strips, known as narrow band coils, is passed via the band control 140 through the intermediate space between the die 130 and the punch guide 131 in order to cover the opening of the die 130. A sheet metal part 11 is subsequently punched from the metal sheet 10 by means of the punch 120. The metal sheet 10 is pushed forward and the process is repeated until the desired stack height 13 of the stack 12 has been reached. The stack height 13 is either measured via the thickness of the metal sheet 10 and converted into the required number of sheet metal parts 11 or a distance of travel or pressure of the punch 120 through the die 130 onto the sheet metal stack 12 is measured 13—i.e. the cold dimension 13 is determined. Depending on the length of the metal sheet stack 13, no or one or more further sheet metal parts are stamped out and conveyed by the punch 120 through the die 130 into the cavity 110.

FIG. 1b shows a schematic depiction of a joining station 200 in which the sheet metal parts 11 are joined to form a metal body 12. The joining station comprises a punch 220 for applying a pressure to the stacked sheet metal parts 11. The stack height 13 is thus firstly detected/monitored and regulated. In particular, a corrective intervention into the active joining process can thus be made on the basis of the measured values during joining of the sheet metal parts 11 to form a metal body 12, for example by regulating the temperature, the duration or the punch pressure. Efficient production of metal bodies 12 can thus be achieved.

Various techniques are known for joining the individual sheet metal parts. The sheet metal parts 11 can, in particular, be welded together or adhesively bonded. As adhesive, it is possible to provide, for example, an epoxide coating, in particular known as baking surface coating.

The joining of the individual sheet metal parts 11 to form a metal body 12 is carried out by means of a precisely controlled heating, hold and cooling process during which the stack of sheet metal parts 11 is kept under pressure by means of the punch 220. In this phase, the adhesive between the individual sheet metal parts 11 can cure. Depending on the adhesive used, the curing process proceeds, for example, via a chemical reaction, evaporation of a solvent or the like.

Heating is preferably carried out by a fluid or direct or indirect electromagnetic, but can also be effected by means of other facilities known to those skilled in the art. For example, heating can also be effected by means of heating cartridges.

The cooling process is likewise preferably actively controlled and is preferably effected by means of a fluid, in particular a cooling air, liquid or a cooling gas. However, a person skilled in the art will also know of other possibilities.

The joining process of each individual metal body 12 is individually monitored and documented. There is therefore a completely documented production history for each individual product.

In a preferred embodiment, the apparatus has a modular construction, so that it is possible to provide a plurality of joining stations which are, in particular, supplied by a single stamping unit.

FIG. 1c shows a schematic depiction of an ejection unit 300. This comprises an ejector 301 which can travel through the outlet opening 112 to eject the metal body 12 from the cavity 110. A person skilled in the art will also know of other techniques; for example, the metal body 12 can be taken out from the cavity 110 by means of compressed air, magnetic graspers or other means.

The transport from the stamping unit 100 to the joining station 200 or from the joining station 200 to the ejection unit 300 is preferably carried out via an automatic device (not shown) or similar transport system, but can also be effected manually.

Further stations for processing, measuring or the like can also be provided between the individual processing stations stamping unit 100, joining station 200 and ejection unit 300. In particular, it is possible to measure not only the geometric dimensions but also other values such as the conductivity, etc., by means of which the parameters of a subsequent process step can be adapted if necessary. Furthermore, the ejection unit 300 can be followed, for example, by a packaging or labelling unit (not shown).

Owing to the high degree of automation of the apparatus, the processes and parameters can be stably comprehended and a constantly high quality level can additionally be ensured.

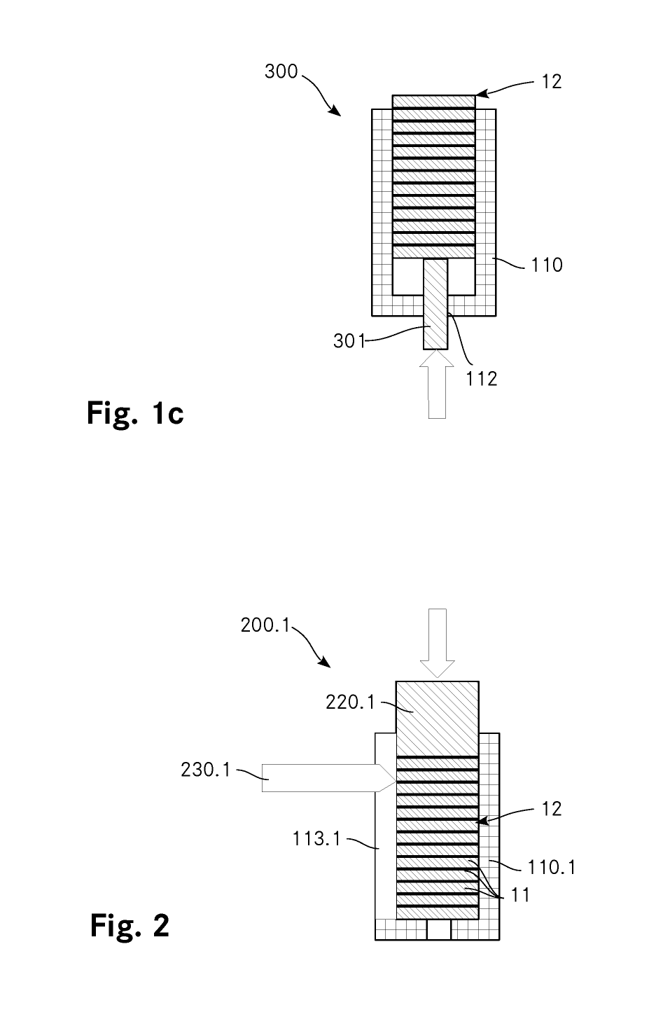

FIG. 2 shows a schematic depiction of a variant of a joining station 200.1, configured as a welding station. In the present embodiment, the cavity 110.1 has at least one slit 113.1 or a cut/opening at the side, through which a welding beam 230.1 can weld together the sheet metal parts 11 to form a metal body 12. During the welding operation, the sheet metal parts 11 are kept under controlled pressure by means of the punch 220.1. Furthermore, parameters, for example as the welding power, the welding speed, the number of welding seams, etc., are monitored and controlled during the welding process. All measurable and controllable parameters can be adapted during the welding process.

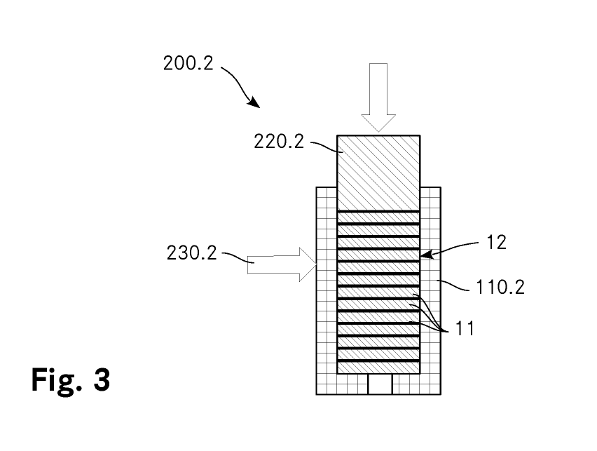

FIG. 3 shows a schematic depiction of a further variant of a joining station 200.2, configured as a heating station. In this embodiment, the sheet metal parts 11 are joined by means of adhesive, for example epoxides, baking surface coating or others. To cure the adhesive, the cavity 110.2 containing the sheet metal parts 11 is heated while the sheet metal parts 11 are pressed together by means of a punch 220.2. As an alternative, it is also possible to use an adhesive which reacts over time, under pressure, under the action of light or the like.

During the heating process, the parameters heating rate, temperature, hold time, pressure on the stack, stack length, cooling power and final temperature after the cooling process are monitored and controlled in such a way that an optimal result in respect of the product quality and the production rate is achieved.

Monitoring is preferably based on rules, tables and formulae of values based on experience. The values based on experience preferably come from the same apparatus; in particular, the data obtained directly from prior productions of metal bodies can also be used.

In summary, it can be stated that the invention provides a process for producing metal bodies, in particular lamination stacks for electric motors, which can produce metal bodies efficiently and essentially autonomously with high quality and a high throughput. The process is preferably self-learning by data from the production of the last metal bodies being used automatically for optimizing the process. An apparatus for carrying out the process can thus be installed at the premises of a manufacturer without specific process and plant know-how. The plant can, in particular, be constructed and operated directly at the place at which the metal bodies produced are processed further.

1. A process for producing metal bodies, in particular for the production of lamination packets for use in electric motors, which comprises the following steps:
a) formation of a stack of a plurality of sheet metal parts in a cavity of a tool, with thermally curing adhesive layers being provided between the sheet metal parts, and
b) heating of the stack to cure the adhesive layers and to form the metal body,
c) with a pressure being applied to the stack during heating,
wherein
d) at least one of the following parameters is measured during the process: applied pressure, temperature of the stack, height of the stack, and in that
e) a prescribed height of the stack is set by use of a temperature-pressure control.

2. The process according to claim 1, wherein the tool is configured as cavity, with the stack being formed within the cavity by means of a stamping operation and, in particular, the cavity completely or partly enclosing the stack.

3. The process according to claim 1, wherein the stack is transferred, preferably fully automatically, to a joining station, in particular by means of a rotating plate or revolving magazine arranged under a stamping tool.

4. The process according to claim 1, wherein the stack is welded or baked together in the joining station to form the metal body.

5. The process according to claim 1, wherein the stack is subjected to a baking process in the joining station, with the stack being heated by a fluid or direct or indirect electromagnetic and subsequently cooled, in particular actively, so as to give a metal body.

6. The process according to claim 1, wherein the stack height in the tool is measured by means of a punch.

7. The process according to claim 1, wherein process parameters, in particular a process parameter selected from among:
a) a rate for heating the stack,
b) a hold time of a temperature after heating of the stack,
c) a pressure with which a stack is pressed together during the heating process,
during the baking process are dynamically adapted individually for each stack, in particular in order to reduce a production time for a metal body.

8. The process according to claim 7, wherein, after cooling of the metal body, the metal body is taken from the cavity, preferably fully automatically, in particular in an ejection station.

9. The process according to claim 1, wherein the process is carried out fully automatically and continuously.

10. The process according to claim 7, wherein the individual process parameters are stored for each metal body produced.

11. The process according to claim 1, wherein the stamping unit, the joining station and the ejection unit are coordinated by means of a control unit.

12. An apparatus for carrying out the process according to claim 1, which comprises a stamping unit, a joining station and an ejection unit, wherein the joining station comprises a plurality of preferably identical joining modules which can be supplied by the stamping unit.

13. The apparatus according to claim 12, wherein it comprises an automatic device for supplying the joining station.

14. The apparatus according to claim 12, wherein the joining station comprises a heating facility, in particular a heating facility by fluids or direct or indirect electromagnetic, and a cooling facility.

15. The process according to claim 1, wherein the entire process preferably proceeds completely automatically.

16. An apparatus for carrying out the process according to claim 2, which comprises a stamping unit, a joining station and an ejection unit, wherein the joining station comprises a plurality of preferably identical joining modules which can be supplied by the stamping unit.

17. An apparatus for carrying out the process according to claim 3, which comprises a stamping unit, a joining station and an ejection unit, wherein the joining station comprises a plurality of preferably identical joining modules which can be supplied by the stamping unit.

18. An apparatus for carrying out the process according to claim 4, which comprises a stamping unit, a joining station and an ejection unit, wherein the joining station comprises a plurality of preferably identical joining modules which can be supplied by the stamping unit.

19. An apparatus for carrying out the process according to claim 5, which comprises a stamping unit, a joining station and an ejection unit, wherein the joining station comprises a plurality of preferably identical joining modules which can be supplied by the stamping unit.

20. An apparatus for carrying out the process according to claim 6, which comprises a stamping unit, a joining station and an ejection unit, wherein the joining station comprises a plurality of preferably identical joining modules which can be supplied by the stamping unit.
